(19) United States
(12) Patent Application Publication
(10) Pub. No.: US 2018/0074858 A1
(43) Pub. Date: Mar. 15, 2018

(54) MULTI-LAYER DISTRIBUTION OF A COMPUTING TASK IN A DISPERSED STORAGE NETWORK

(71) Applicant: International Business Machines Corporation, Armonk, NY (US)

(72) Inventors: Gary W. Grube, Barrington Hills, IL (US); Timothy W. Markison, Mesa, AZ (US)

(21) Appl. No.: 15/822,333

(22) Filed: Nov. 27, 2017

Related U.S. Application Data
(63) Continuation-in-part of application No. 15/444,952, filed on Feb. 28, 2017.
Application No. 15/444,952 is a continuation-in-part of application No. 13/865,641, filed on Apr. 18, 2013, now abandoned.
Application No. 13/865,641 is a continuation-in-part of application No. 13/707,490, filed on Dec. 6, 2012, now Pat. No. 9,304,857.
(60) Provisional application No. 61/569,387, filed on Dec. 12, 2011.

(51) Int. Cl. G06F 9/48; G06F 9/50; H04L 29/08; G06F 3/06; G06F 11/10

(52) U.S. Cl. CPC G06F 9/4881; G06F 9/5077; H04L 67/1097; G06F 3/067; G06F 2211/1028; G06F 3/0604; G06F 3/0619; G06F 11/1076; G06F 3/064

(57) ABSTRACT

Methods for use in a dispersed storage network (DSN) to determine distribution of computing tasks. A computing device receives a partial task and associated contiguous data and determines whether to process the partial task locally. When processing locally, the computing device determines execution steps and a schedule, identifies a portion of the contiguous data, and executes the execution steps, in accordance with the schedule, on the portion of data to produce a partial result. When not processing the partial task locally, the computing device selects a portion of the contiguous data and determines processing parameters based. The computing device further determines task partitioning to transform the partial task into one or more secondary partial tasks, processes the select data in accordance with the processing parameters to produce secondary data, and sends the secondary data and one or more corresponding secondary partial tasks to storage units of the DSN.

### CROSS-REFERENCE TO RELATED APPLICATIONS

The present U.S. Utility patent application claims priority pursuant to 35 U.S.C. § 120 as a continuation-in-part of U.S. Utility application Ser. No. 15/444,952, entitled “PARTIAL TASK ALLOCATION IN A DISPERSED STORAGE NETWORK”, filed Feb. 28, 2017, which is a continuation-in-part of U.S. Utility application Ser. No. 13/865,641, entitled “DISPERSED STORAGE NETWORK SECURE HIERARCHICAL FILE DIRECTORY”, filed Apr. 18, 2013, which is a continuation-in-part of U.S. Utility application Ser. No. 13/707,490, entitled “RETRIEVING DATA FROM A DISTRIBUTED STORAGE NETWORK”, filed Dec. 6, 2012, now issued as U.S. Pat. No. 9,304,857, which claims priority pursuant to 35 U.S.C. § 119(e) to U.S. Provisional Application No. 61/569,387, entitled “DISTRIBUTED STORAGE AND TASK PROCESSING”, filed Dec. 12, 2011, all of which are hereby incorporated herein by reference in their entirety and made part of the present U.S. Utility patent application for all purposes

### BACKGROUND

This invention relates generally to computer networks, and more specifically, to distribution of computing tasks in a dispersed storage network.

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on a remote storage system. The remote storage system may include a RAID (redundant array of independent disks) system and/or a dispersed storage system that uses an error correction scheme to encode data for storage.

In a RAID system, a RAID controller adds parity data to the original data before storing it across an array of disks. The parity data is calculated from the original data such that the failure of a single disk typically will not result in the loss of the original data. While RAID systems can address certain memory device failures, these systems may suffer from effectiveness, efficiency and security issues. For instance, as more disks are added to the array, the probability of a disk failure rises, which may increase maintenance costs. When a disk fails, for example, it needs to be manually replaced before another disk(s) fails and the data stored in the RAID system is lost. To reduce the risk of data loss, data on a RAID device is often copied to one or more other RAID devices. While this may reduce the possibility of data loss, it also raises security issues since multiple copies of data may be available, thereby increasing the chances of unauthorized access. In addition, co-location of some RAID devices may result in a risk of a complete data loss in the event of a natural disaster, fire, power surge/outage, etc.

### SUMMARY

According to embodiments of the present disclosure, novel methods are presented for use in a dispersed storage network (DSN) to determine appropriate distribution of computing tasks. In various examples, at least one partial task and an associated group of slices of contiguous data are received. Based on various criteria, a determination is made whether to process the partial task locally. When determining to process the task locally, execution steps and a schedule are determined, a portion of the contiguous data for execution of one or more steps of the execution steps is identified, and the one or more steps are executed, in accordance with the schedule, on the portion of the contiguous data to produce a partial result. When determining not to process the at least one partial task locally, a portion of the contiguous data is selected and processing parameters of the select data are determined based, at least in part, on a number of storage units. Task partitioning is also determined, based on the number of storage units and the processing parameters, to transform the at least one partial task into one or more secondary partial tasks. The select data is processed in accordance with the processing parameters to produce secondary slice groupings, and the secondary slice groupings and one or more corresponding secondary partial tasks are set to storage units of the DSN.

### BRIEF DESCRIPTION OF THE DRAWINGS

FIG. 1 is a schematic block diagram of an embodiment of a dispersed or distributed storage network (DSN) in accordance with the present disclosure;

FIG. 2 is a schematic block diagram of an example of a computing core in accordance with an embodiment of the present disclosure;

FIG. 3 is a schematic block diagram of an example of dispersed storage error encoding of data in accordance with and embodiment of the present disclosure;

FIG. 4 is a schematic block diagram of a generic example of an error encoding function in accordance with the present disclosure;

FIG. 5 is a schematic block diagram of a specific example of an error encoding function in accordance with the present disclosure;

FIG. 6 is a schematic block diagram of an example of slice naming information for an encoded data slice (EDS) in accordance with the present disclosure;

FIG. 7 is a schematic block diagram of an example of dispersed storage error decoding of data in accordance with an embodiment of the present disclosure;

FIG. 8 is a schematic block diagram of a generic example of an error decoding function in accordance with an embodiment of the present disclosure;

FIG. 9 is a schematic block diagram of an example of distributed storage and task processing in accordance with an embodiment of the present disclosure;

FIG. 10 is a schematic block diagram of an example of outbound distributed storage and task processing in accordance with an embodiment of the present disclosure;

FIG. 11 is a flow diagram illustrating an example of a method for outbound distributed storage and task processing in accordance with an embodiment of the present disclosure;

FIG. 12 is a schematic block diagram of an example of outbound processing of a partial task in accordance with an embodiment of the present disclosure; and

FIG. 13 is a flow diagram illustrating an example of transforming a partial task into secondary partial tasks in accordance with an embodiment of the present disclosure.

### DETAILED DESCRIPTION

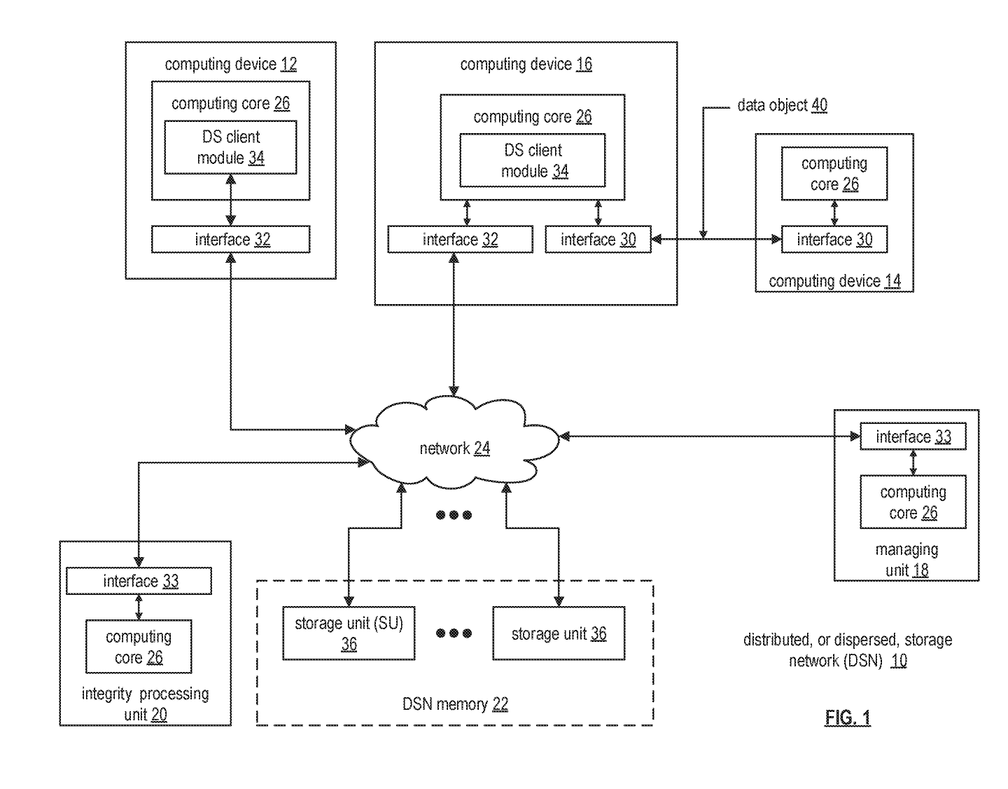

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

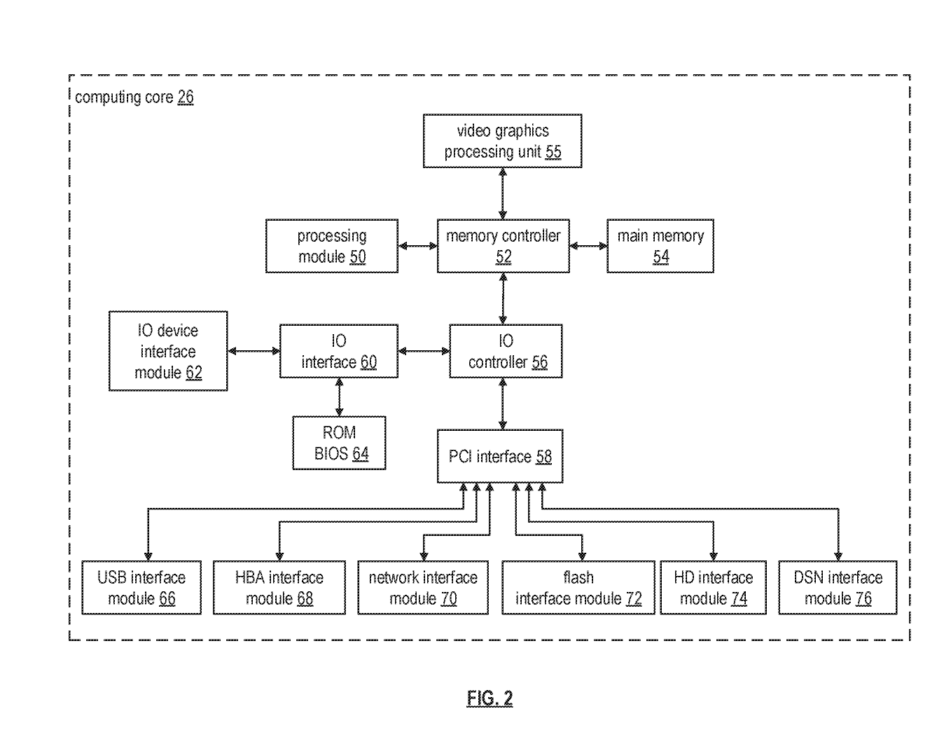

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more than or less than eight storage units 36. Further note that each storage unit 36 includes a computing core (as shown in FIG. 2, or components thereof) and a plurality of memory devices for storing dispersed storage (DS) error encoded data.

Each of the storage units 36 is operable to store DS error encoded data and/or to execute (e.g., in a distributed manner) maintenance tasks and/or data-related tasks. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, maintenance tasks (e.g., rebuilding of data slices, updating hardware, rebooting software, restarting a particular software process, performing an upgrade, installing a software patch, loading a new software revision, performing an off-line test, prioritizing tasks associated with an online test, etc.), etc.

Each of the computing devices 12-16, the managing unit 18, integrity processing unit 20 and (in various embodiments) the storage units 36 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

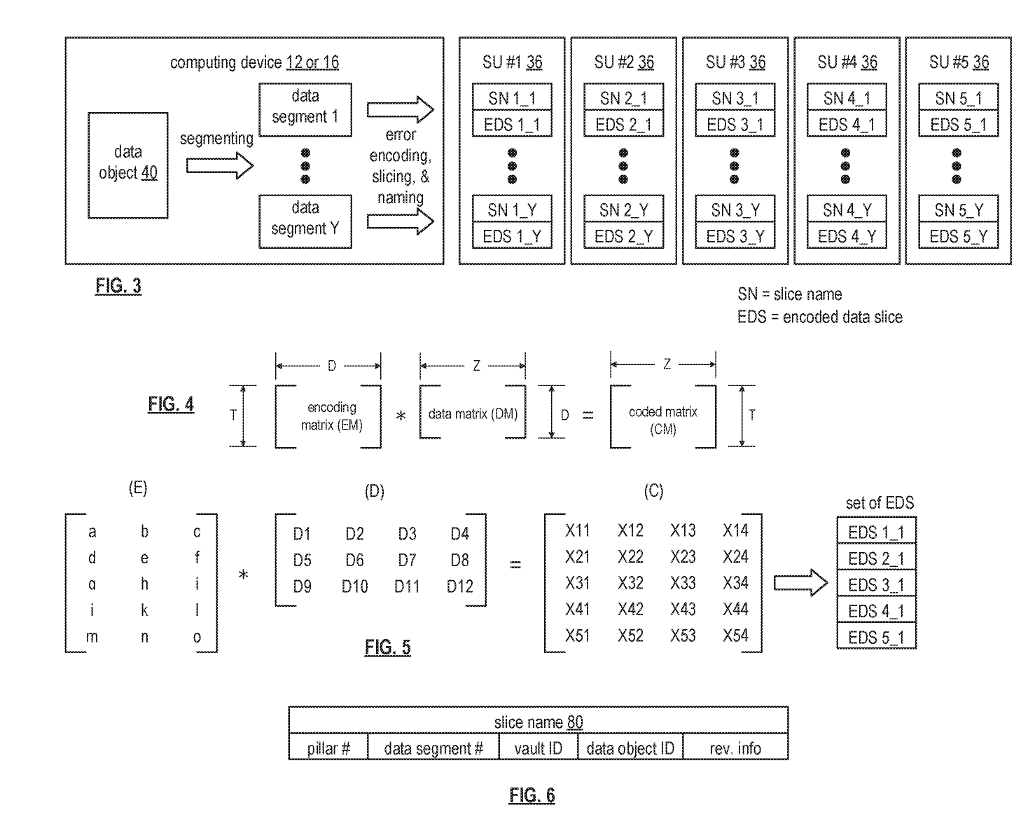

Computing devices 12 and 16 include a dispersed storage (DS) client module 34, which enables the computing device to dispersed storage error encode and decode data (e.g., data object 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate per-access billing information. In another instance, the managing unit 18 tracks the amount of data stored and/or retrieved by a user device and/or a user group, which can be used to generate per-data-amount billing information.

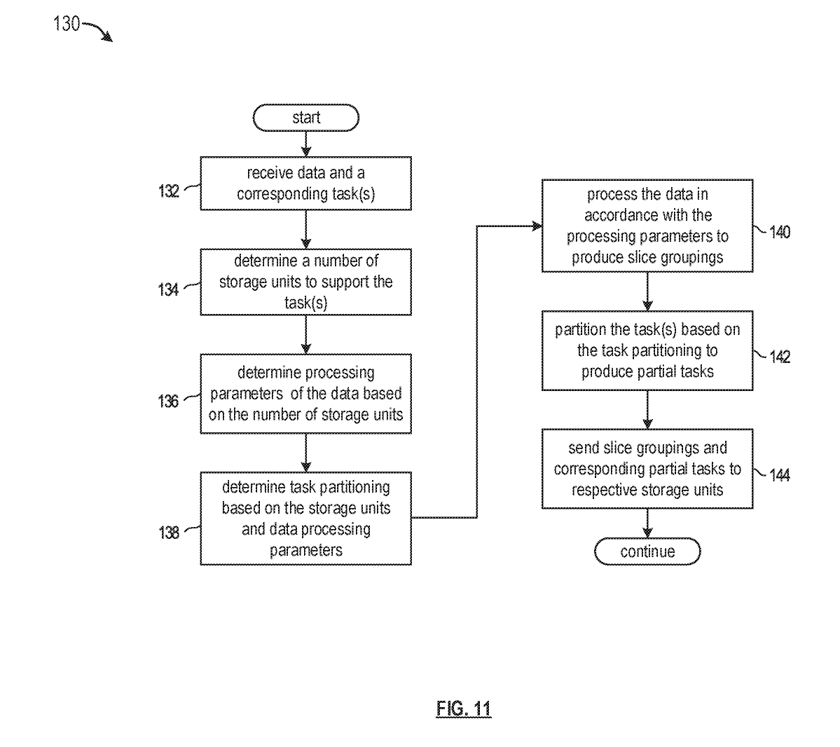

As another example, the managing unit 18 performs network operations, network administration, and/or network maintenance. Network operations includes authenticating user data allocation/access requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10. Examples of distribution of computing tasks are discussed in greater detail with reference to FIGS. 9-13.

To support data storage integrity verification within the DSN 10, the integrity processing unit 20 (and/or other devices in the DSN 10) may perform rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. Retrieved encoded slices are checked for errors due to data corruption, outdated versioning, etc. If a slice includes an error, it is flagged as a ‘bad’ or ‘corrupt’ slice. Encoded data slices that are not received and/or not listed may be flagged as missing slices. Bad and/or missing slices may be subsequently rebuilt using other retrieved encoded data slices that are deemed to be good slices in order to produce rebuilt slices. A multi-stage decoding process may be employed in certain circumstances to recover data even when the number of valid encoded data slices of a set of encoded data slices is less than a relevant decode threshold number. The rebuilt slices may then be written to DSN memory 22. Note that the integrity processing unit 20 may be a separate unit as shown, included in DSN memory 22, included in the computing device 16, and/or distributed among the storage units 36.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of five, a decode threshold of three, a read threshold of four, and a write threshold of four. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number. In the illustrated example, the value X11=aD1+bD5+cD9, X12=aD2+bD6+cD10, . . . X53=mD3+nD7+oD11, and X54=mD4+nD8+oD12.

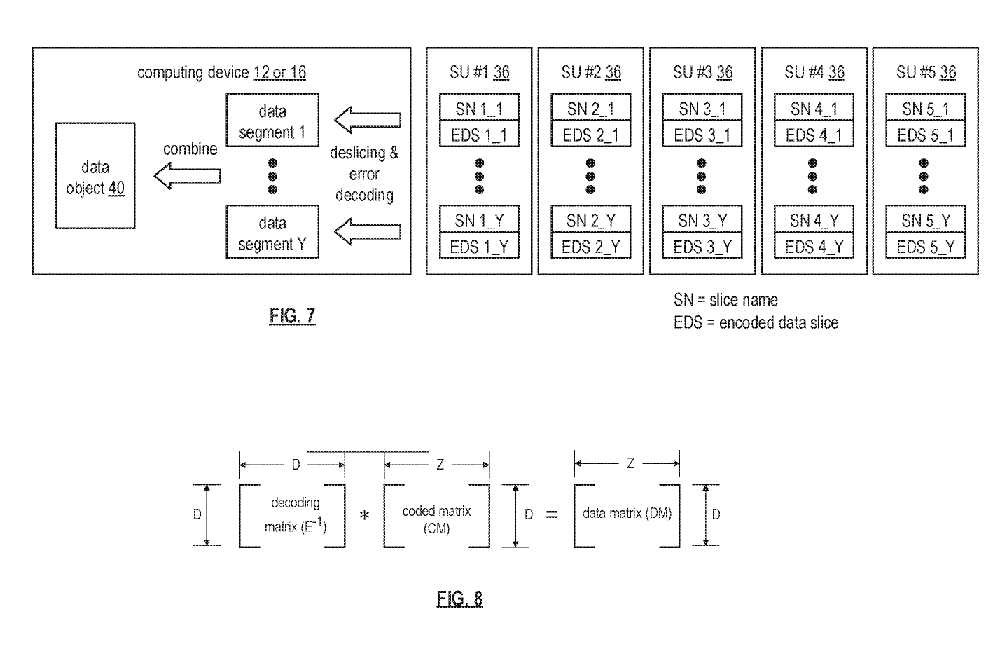

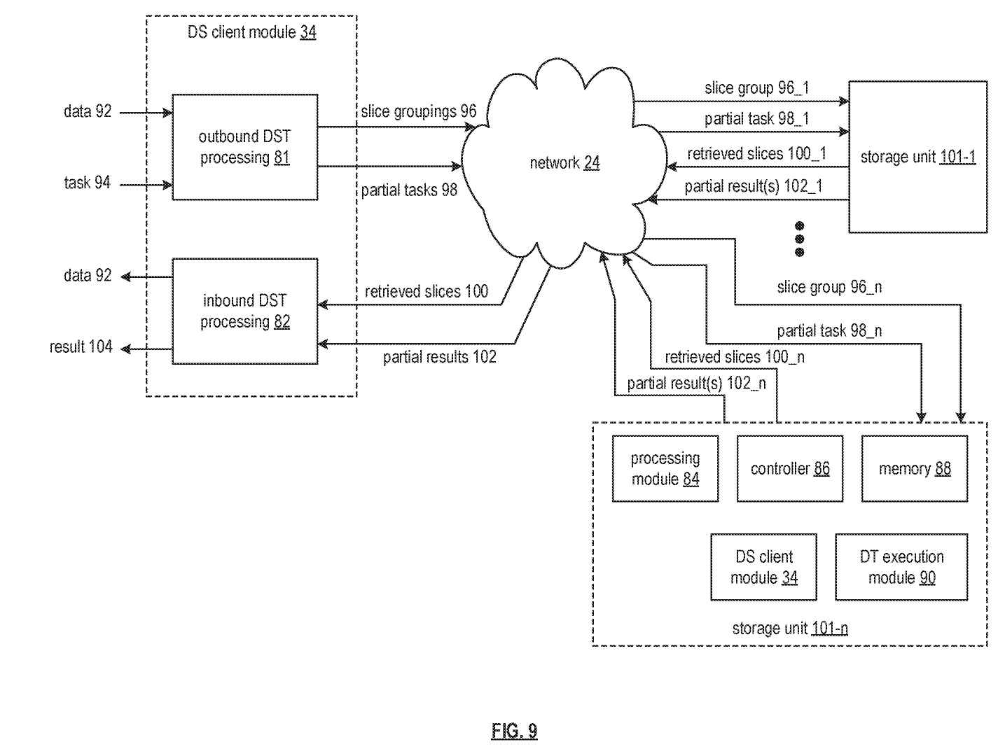

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as at least part of a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

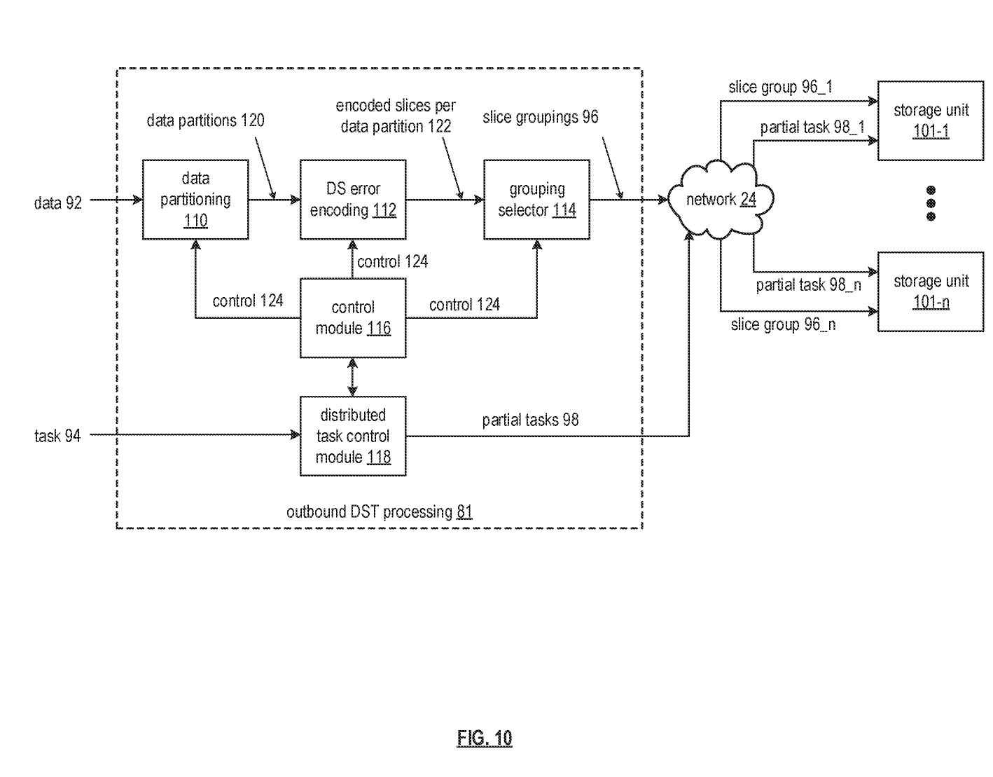

In order to recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

Referring now to FIG. 9, a schematic block diagram of an example of distributed storage and task processing in accordance with an embodiment of the present disclosure is shown. The distributed computing system includes a DS (distributed storage and/or task) client module 34 (which may be included in computing devices 12-18 of FIG. 1), a network 24, a plurality of storage units 101-1 . . . 101-n that includes two or more storage units which, for example, form at least a portion of DSN memory 22 of FIG. 1, a managing unit 18 (not shown), and an integrity processing unit 20 (not shown). The DS client module 34 includes an outbound distributed storage and/or task (DST) processing section 81 and an inbound DST processing section 82. Each of the storage units 1-n includes a controller 86, a processing module 84, memory 88, a DT (distributed task) execution module 90, and a DS client module 34.

In an example of operation, the DS client module 34 receives data 92 and one or more tasks 94 to be performed upon the data 92. The data 92 may be of any size and of any content, where, due to the size (e.g., greater than a few Terra-Bytes), the content (e.g., secure data, etc.), and/or task(s) (e.g., MIPS intensive), distributed processing of the task(s) on the data is desired. For example, the data 92 may be one or more digital books, a copy of a company's emails, a large-scale Internet search, a video security file, one or more entertainment video files (e.g., television programs, movies, etc.), data files, and/or any other large amount of data (e.g., greater than a few Terra-Bytes).

Within the DS client module 34, the outbound DST processing section 81 receives the data 92 and the task(s) 94. The outbound DST processing section 81 processes the data 92 to produce slice groupings 96. As an example of such processing, the outbound DST processing section 81 partitions the data 92 into a plurality of data partitions. For each data partition, the outbound DST processing section 81 dispersed storage (DS) error encodes the data partition to produce encoded data slices and groups the encoded data slices into a slice grouping 96. In addition, the outbound DST processing section 81 partitions the task 94 into partial tasks 98, where the number of partial tasks 98 may correspond to the number of slice groupings 96.

The outbound DST processing section 81 then sends, via the network 24, the slice groupings 96 and the partial tasks 98 to the storage units 101-1 . . . 101-n of the DSN memory 22 of FIG. 1. For example, the outbound DST processing section 81 sends slice group 96_1 and partial task 98_1 to storage unit 101-1. As another example, the outbound DST processing section 81 sends slice group 96_n and partial task 98_n to storage unit 101-n.

Each storage unit performs its partial task 98 upon its slice group 96 to produce partial results 102. For example, storage unit 101-1 performs partial task 98_1 on slice group 96_1 to produce a partial result 100_1. As a more specific example, slice group 96_1 corresponds to a data partition of a series of digital books and the partial task 98_1 corresponds to searching for specific phrases, recording where the phrase is found, and establishing a phrase count. In this more specific example, the partial result 102_1 includes information as to where the phrase was found and includes the phrase count.

Upon completion of generating their respective partial results 102, the storage units 101 send, via the network 24, respective partial results 102 to the inbound DST processing section 82 of the DS client module 34. The inbound DST processing section 82 processes the received partial results 102 to produce a result 104. Continuing with the specific example of the preceding paragraph, the inbound DST processing section 82 combines the phrase count from each of the storage units 101-1 . . . 101-n to produce a total phrase count. In addition, the inbound DST processing section 82 combines the ‘where the phrase was found’ information from each of the storage units 101-1 . . . 101-n within their respective data partitions to produce ‘where the phrase was found’ information for the series of digital books.

In another example of operation, the DS client module 34 requests retrieval of stored data within the memory of the storage units 101 (e.g., memory of the DSN). In this example, the task 94 is retrieve data stored in the memory of the DSN. Accordingly, the outbound DST processing section 81 converts the task 94 into a plurality of partial tasks 98 and sends the partial tasks 98 to the respective storage units 101.

In response to the partial task 98 of retrieving stored data, a storage unit 101 identifies the corresponding encoded data slices and retrieves them. For example, storage unit 101-1 receives partial task 98_1 and retrieves, in response thereto, retrieved slices 100_1. The storage units 101 send their respective retrieved slices 100 to the inbound DST processing section 82 via the network 24.

The inbound DST processing section 82 converts the retrieved slices 100 into data 92. For example, the inbound DST processing section 82 de-groups the retrieved slices 100 to produce encoded slices per data partition. The inbound DST processing section 82 then DS error decodes the encoded slices per data partition to produce data partitions. The inbound DST processing section 82 de-partitions the data partitions to recapture the data 92.

FIG. 10 is a schematic block diagram of an embodiment of an outbound distributed storage and/or task (DST) processing section 81 of a DS client module 34 coupled to a DSN memory 22 of a FIG. 1 (e.g., a plurality of n storage units 101) via a network 24. The outbound DST processing section 81 includes a data partitioning module 110, a dispersed storage (DS) error encoding module 112, a grouping selector module 114, a control module 116, and a distributed task control module 118.

In an example of operation, the data partitioning module 110 partitions data 92 into a plurality of data partitions 120. The number of partitions and the size of the partitions may be selected by the control module 116 via control 124 based on the data 92 (e.g., its size, its content, etc.), a corresponding task 94 to be performed (e.g., simple, complex, single step, multiple steps, etc.), DS encoding parameters (e.g., pillar width, decode threshold, write threshold, segment security parameters, slice security parameters, etc.), capabilities of the storage units 36 (e.g., processing resources, availability of processing recourses, etc.), and/or as may be inputted by a user, system administrator, or other operator (human or automated). For example, the data partitioning module 110 partitions the data 92 (e.g., 100 Terra-Bytes) into 100,000 data segments, each being 1 Giga-Byte in size. Alternatively, the data partitioning module 110 partitions the data 92 into a plurality of data segments, where some of data segments are of a different size, are of the same size, or a combination thereof.

The DS error encoding module 112 receives the data partitions 120 in a serial manner, a parallel manner, and/or a combination thereof. For each data partition 120, the DS error encoding module 112 DS error encodes the data partition 120 in accordance with control information 124 from the control module 116 to produce encoded data slices 122. The DS error encoding includes segmenting the data partition into data segments, segment security processing (e.g., encryption, compression, watermarking, integrity check (e.g., CRC), etc.), error encoding, slicing, and/or per slice security processing (e.g., encryption, compression, watermarking, integrity check (e.g., CRC), etc.). The control information 124 indicates which steps of the DS error encoding are active for a given data partition and, for active steps, indicates the parameters for the step. For example, the control information 124 indicates that the error encoding is active and includes error encoding parameters (e.g., pillar width, decode threshold, write threshold, read threshold, type of error encoding, etc.).

The group selecting module 114 groups the encoded slices 122 of a data partition into a set of slice groupings 96_1 . . . 96_n. The number of slice groupings corresponds to the number of storage units 36 identified for a particular task 94. For example, if five storage units 101 are identified for the particular task 94, the group selecting module groups the encoded slices 122 of a data partition into five slice groupings 96. The group selecting module 114 outputs the slice groupings 96 to the corresponding storage units 101 via the network 24.

The distributed task control module 118 receives the task 94 and converts the task 94 into a set of partial tasks 98_1 . . . 98_n. For example, the distributed task control module 118 receives a task to find where in the data (e.g., a series of books) a phrase occurs and a total count of the phrase usage in the data. In this example, the distributed task control module 118 replicates the task 94 for each storage unit 101 to produce the partial tasks 98. In another example, the distributed task control module 118 receives a task to find where in the data a first phrase occurs, wherein in the data a second phrase occurs, and a total count for each phrase usage in the data. In this example, the distributed task control module 118 generates a first set of partial tasks 98 for finding and counting the first phase and a second set of partial tasks for finding and counting the second phrase. The distributed task control module 118 sends respective first and/or second partial tasks 98 to each storage unit 101.

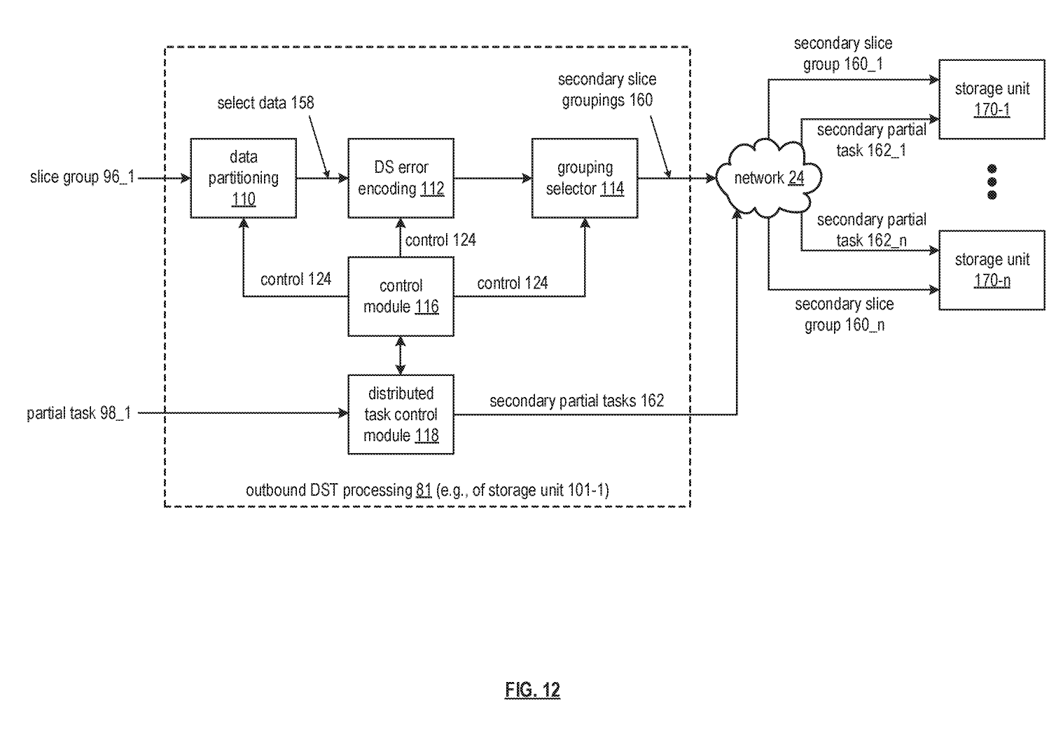

FIG. 11 is a flow diagram illustrating an example of a method 130 for outbound distributed storage and task processing in accordance with an embodiment of the present disclosure. The method begins at step 132 where a DS client module receives data and one or more corresponding tasks. The method continues at step 134 where the DS client module determines a number of storage units to support the task for one or more data partitions. For example, the DS client module may determine the number of storage units to support the task based on the size of the data, the requested task, the content of the data, a predetermined number (e.g., user indicated, system administrator determined, etc.), available DST units, capability of the DST units, and/or any other factor regarding distributed task processing of the data. The DS client module may select the same DST units for each data partition, may select different DST units for the data partitions, or a combination thereof.

The method continues at step 136 where the DS client module determines processing parameters of the data based on the number of storage units selected for distributed task processing. The processing parameters include data partitioning information, DS encoding parameters, and/or slice grouping information. The data partitioning information includes a number of data partitions, size of each data partition, and/or organization of the data partitions (e.g., number of data blocks in a partition, the size of the data blocks, and arrangement of the data blocks). The DS encoding parameters include segmenting information, segment security information, error encoding information (e.g., dispersed storage error encoding function parameters including one or more of pillar width, decode threshold, write threshold, read threshold, generator matrix), slicing information, and/or per slice security information. The slice grouping information includes information regarding how to arrange the encoded data slices into groups for the selected DST units. As a specific example, if the DS client module determines that five DST units are needed to support the task, then it determines that the error encoding parameters include a pillar width of five and a decode threshold of three.

The method continues at step 138 where the DS client module determines task partitioning information (e.g., how to partition the tasks) based on the selected DST units and data processing parameters. The data processing parameters include the processing parameters and DST unit capability information. The DST unit capability information includes the number of DT (distributed task) execution units, execution capabilities of each DT execution unit (e.g., MIPS capabilities, processing resources (e.g., quantity and capability of microprocessors, CPUs, digital signal processors, co-processor, microcontrollers, arithmetic logic circuitry, and/or and the other analog and/or digital processing circuitry), availability of the processing resources, memory information (e.g., type, size, availability, etc.)), and/or any information germane to executing one or more tasks.

The method continues at step 140 where the DS client module processes the data in accordance with the processing parameters to produce slice groupings. The method continues at step 142 where the DS client module partitions the task based on the task partitioning information to produce a set of partial tasks. The method continues at step 144 where the DS client module sends the slice groupings and the corresponding partial tasks to respective storage units.

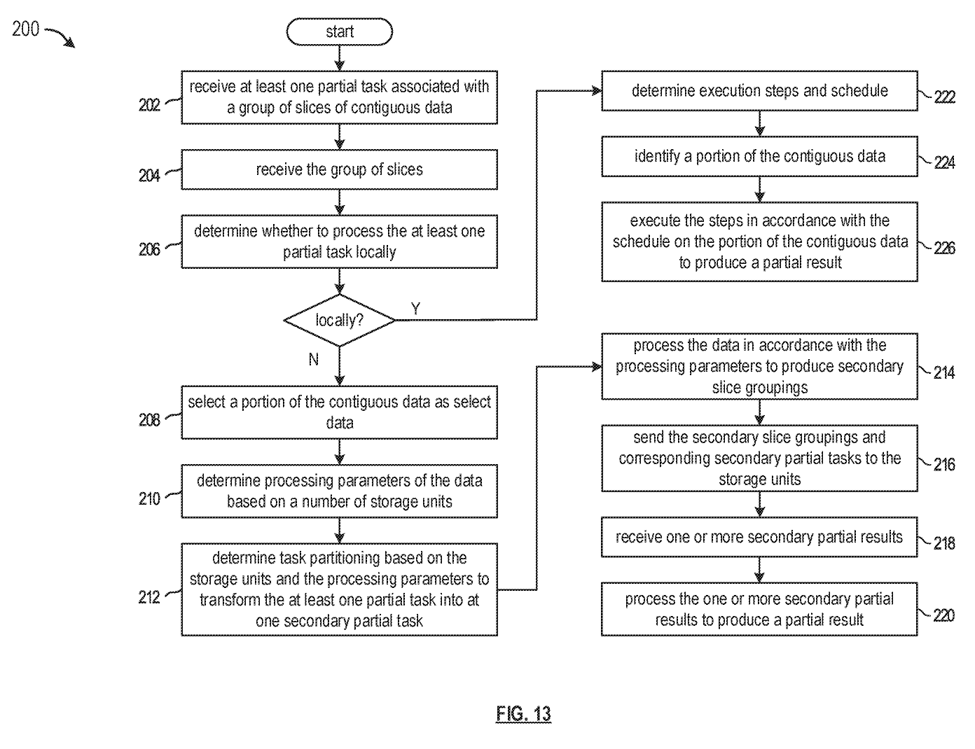

FIG. 12 is a schematic block diagram of an example of outbound processing of a partial task in accordance with an embodiment of the present disclosure. The illustrated outbound distributed storage and/or task (DST) processing section 81 of a DS client module 34 is coupled to a DSN memory 22 of a FIG. 1 (e.g., a plurality of n storage units 170-1 . . . 170-n) via a network 24. The outbound DST processing section 81 includes a data partitioning module 110, a dispersed storage (DS) error encoding module 112, a grouping selector module 114, a control module 116, and a distributed task control module 118.

The DST processing section 81 operates generally as described above in conjunction with the DST processing section 81 of FIG. 10, and as further described below in conjunction with the example method of FIG. 13. In an example of operation, the data partitioning module 110 receives a slice grouping 96_1 (e.g., of FIG. 10) and partitions the slice grouping, or select data 158 thereof, into a plurality of data partitions. The DS error encoding module 112, in accordance with control information 124 from control module 116, produces encoded data slices for provision to grouping selector 114. The grouping selector 114 of this example groups the encoded data slices into secondary slice groupings 160_1 . . . 160_n for provision to corresponding storage units 170-1 . . . 170-n via the network 24.

The distributed task control module 118 of this example receives a partial task (e.g., partial task 98_1 of FIG. 10) and converts the partial task 94 into a set of secondary partial tasks 162_1 . . . 162_n. The distributed task control module 118 then sends the secondary partial tasks 162 to corresponding storage units 170-1 . . . 170-n, via the network 24, for use in further processing of the secondary slice groupings 160. Converting secondary partial tasks 162 may be based, for example and without limitation, on the relative execution capacity levels of storage unit 101-1 and one or more of storage units 170-1 . . . 170-n, a required partial task execution capacity level, an amount of data of the slice group 96_1, a partial task type, partial task execution resource availability, and a partial task schedule.

FIG. 13 is a flow diagram illustrating a method 200 of transforming a partial task into secondary partial tasks in accordance with an embodiment of the present disclosure. The method begins at step 202 when a processing module (e.g., of a storage unit or distributed storage and task (DST) execution unit) receives at least one partial task with regards to a group of slices of contiguous data, and continues with step 204 where the processing module receives the group of slices. The method continues at step 206 where the processing module determines whether to process the at least one partial task locally. The determining may be based on one or more of a local task execution capacity level, a required task execution capacity level (e.g., to execute the partial task within a required task execution timeframe), and a comparison of the difference between the local task execution capacity level and the required task execution capacity level to a difference threshold. For example, the processing module determines to process the at least one partial task locally when the difference compares favorably to the difference threshold (e.g., local task execution meets the required task execution timeframe). In other examples, determining whether to process the at least one partial task locally may be based on comparing an amount of data of the group of slices to a data threshold, a partial task type, task execution resource availability, and a task schedule.

The method branches to step 208 when the processing module determines not to process the at least one partial task locally. The method continues to step 222 when the processing module determines to process the at least one partial task locally. At step 222, the processing module determines execution steps and schedule for processing the at least one partial task. Next, at step 224, the processing module identifies a portion of the contiguous data, and executes (step 226) the execution steps in accordance with the schedule on the identified portion of the contiguous data to produce a partial result.

When determining not to process the at least one partial task locally, the method continues at step 208 where the processing module selects a portion of the contiguous data as data when the processing module determines not to process the at least one partial task locally. The selecting includes determining which portion to process locally and which portions to process with other storage units based on one or more of storage unit task execution capacity and the required task execution timeframe such that the partial task is executed within the required timeframe. The method continues with step 210 where the processing module determines processing parameters of the data based, at least in part, on a number of storage units.

The method continues at step 212 where the processing module determines task partitioning based on the relevant storage units and the processing parameters to transform the at least one partial task into one or more secondary partial tasks. For example, the processing module determines partitioning to form one or more sub-tasks as the at least one secondary partial tasks for execution by the number of other storage units. The method continues at step 214 where the processing module processes the data in accordance with the processing parameters to produce secondary slice groupings. For example, the processing module generates groups of slices in accordance with the processing parameters to produce the secondary slice groupings.

The method continues at step 216 where the processing module sends the secondary slice groupings and corresponding secondary partial tasks to the delegated storage units. The method continues at step 218 where the processing module receives one or more secondary partial results (e.g., from the storage units). The method continues at step 220 where the processing module processes the one or more secondary partial results to produce a partial result. The processing includes at least one of decoding and/or aggregating the one or more secondary partial results. In addition, the processing module may send the partial result to a requesting entity and/or facilitate storing of the partial result in a distributed storage network (DSN).

The methods described above in conjunction with the computing devices 16 and storage units 36 can alternatively be performed by other modules (e.g., DS client modules 34) of a dispersed storage network or by other devices (e.g., managing unit 18). Any combination of a first module, a second module, a third module, a fourth module, etc. of the computing devices and the storage units may perform the method described above. In addition, at least one memory section (e.g., a first memory section, a second memory section, a third memory section, a fourth memory section, a fifth memory section, a sixth memory section, etc. of a non-transitory computer readable storage medium) that stores operational instructions/program instructions can, when executed by one or more processing modules of one or more computing devices and/or by the storage units of the dispersed storage network (DSN), cause the one or more computing devices and/or the storage units to perform any or all of the method steps described above.

As may be used herein, the terms “substantially” and “approximately” provide an industry-accepted tolerance for its corresponding term and/or relativity between items. Such an industry-accepted tolerance ranges from less than one percent to fifty percent. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained. For example, two blocks shown in succession may, in fact, be executed substantially concurrently, or the blocks may sometimes be executed in the reverse order, depending upon the functionality involved. It will also be noted that each block of the block diagrams and/or flow diagrams, and combinations of blocks in the block diagrams and/or flow diagrams, can be implemented by special purpose hardware-based systems that perform the specified functions or acts or carry out combinations of special purpose hardware and computer instructions.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be one or more tangible devices that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of a computing device of a dispersed storage network (DSN), the method comprises:
receiving at least one partial task associated with a group of slices of contiguous data;
receiving the group of slices of contiguous data;
determining whether to process the at least one partial task locally;
when determining to process the at least one partial task locally:
determining execution steps and a schedule;
identifying a portion of the contiguous data for execution of one or more steps of the execution steps; and
executing the one or more steps of the execution steps, in accordance with the schedule, on the portion of the contiguous data to produce a partial result;
when determining not to process the at least one partial task locally:
selecting a portion of the contiguous data as select data;
determining processing parameters of the select data based, at least in part, on a number of storage units;
determining task partitioning, based on the number of storage units and the processing parameters, to transform the at least one partial task into one or more secondary partial tasks;
processing the select data in accordance with the processing parameters to produce secondary slice groupings; and
sending the secondary slice groupings and one or more corresponding secondary partial tasks to storage units of the DSN.

2. The method of claim 1 further comprises:
when determining not to process the at least one partial task locally:
receiving, from the storage units, one or more secondary partial results; and
processing the one or more secondary partial results to produce a partial result for the at least one partial task.

3. The method of claim 2, wherein processing the one or more secondary partial results includes at least one of decoding the one or more secondary partial results or aggregating the one or more secondary partial results.

4. The method of claim 3 further comprises sending the partial result to a requesting entity.

5. The method of claim 3 further comprises facilitating storage of the partial result in the DSN.

6. The method of claim 1, wherein determining whether to process the at least one partial task locally is based on one or more of a local task execution capacity level, a required task execution capacity level, or a comparison of the difference of the local task execution capacity level and the required task execution capacity level to a difference threshold.

7. The method of claim 6 further comprises:
determining to process the at least one partial task locally when the difference of the local task execution capacity level and the required task execution capacity level compares favorably to the difference threshold.

8. The method of claim 1, wherein determining whether to process the at least one partial task locally is based on one or more of comparing an amount of data of the group of slices of contiguous data to a data threshold, a partial task type, task execution resource availability, or a task schedule.

9. A computing device for use in a dispersed storage network (DSN), the computing device comprises:
a network interface;
a local memory comprising instructions; and
a processing module operably coupled to the network interface and the local memory, wherein the processing module executes the instructions to:
receive, via the network interface, at least one partial task associated with a group of slices of contiguous data;
receive the group of slices of contiguous data;
determine whether to process the at least one partial task locally;
when determining to process the at least one partial task locally:
determine execution steps and a schedule;
identify a portion of the contiguous data for execution of one or more steps of the execution steps; and
execute the one or more steps of the execution steps, in accordance with the schedule, on the portion of the contiguous data to produce a partial result;
when determining not to process the at least one partial task locally:
select a portion of the contiguous data as select data;
determine processing parameters of the select data based, at least in part, on a number of storage units;
determine task partitioning, based on the number of storage units and the processing parameters, to transform the at least one partial task into one or more secondary partial tasks;
process the select data in accordance with the processing parameters to produce secondary slice groupings; and
send, via the network interface, the secondary slice groupings and one or more corresponding secondary partial tasks to storage units of the DSN.

10. The computing device of claim 9, wherein the processing module further executes the instructions to:
when determining not to process the at least one partial task locally:
receive, via the network interface, one or more secondary partial results; and
process the one or more secondary partial results to produce a partial result for the at least one partial task.

11. The computing device of claim 10, wherein processing the one or more secondary partial results includes at least one of decoding the one or more secondary partial results or aggregating the one or more secondary partial results.

12. The computing device of claim 11, wherein the processing module further executes the instructions to:
send, via the network interface, the partial result to a requesting entity.

13. The computing device of claim 11, wherein the processing module further executes the instructions to:
facilitate storage of the partial result in the DSN.

14. The computing device of claim 9, wherein determining whether to process the at least one partial task locally is based on one or more of a local task execution capacity level, a required task execution capacity level, or a comparison of the difference of the local task execution capacity level and the required task execution capacity level to a difference threshold.

15. The computing device of claim 14, wherein the processing module further executes the instructions to:
determine to process the at least one partial task locally when the difference of the local task execution capacity level and the required task execution capacity level compares favorably to the difference threshold.

16. The computing device of claim 9, wherein determining whether to process the at least one partial task locally is based on one or more of comparing an amount of data of the group of slices of contiguous data to a data threshold, a partial task type, task execution resource availability, or a task schedule.

17. A computer readable storage medium having operational instructions embodied therewith, the operational instructions executable by one or more processing modules of a dispersed storage network (DSN) to cause the one or more processing modules to:
receive at least one partial task associated with a group of slices of contiguous data;
receive the group of slices of contiguous data;
determine whether to process the at least one partial task locally;
when determining to process the at least one partial task locally:
determine execution steps and a schedule;
identify a portion of the contiguous data for execution of one or more steps of the execution steps; and
execute the one or more steps of the execution steps, in accordance with the schedule, on the portion of the contiguous data to produce a partial result;
when determining not to process the at least one partial task locally:
select a portion of the contiguous data as select data;
determine processing parameters of the select data based, at least in part, on a number of storage units;
determine task partitioning, based on the number of storage units and the processing parameters, to transform the at least one partial task into one or more secondary partial tasks;
process the select data in accordance with the processing parameters to produce secondary slice groupings; and
send the secondary slice groupings and one or more corresponding secondary partial tasks to storage units of the DSN.

18. The computer readable storage medium of claim 17, wherein the operational instructions are further executable to cause the one or more processing modules to:
when determining not to process the at least one partial task locally:
receive, from the storage units, one or more secondary partial results; and
process the one or more secondary partial results to produce a partial result for the at least one partial task.

19. The computer readable storage medium of claim 18, wherein processing the one or more secondary partial results includes at least one of decoding the one or more secondary partial results or aggregating the one or more secondary partial results.

20. The computer readable storage medium of claim 19, wherein the operational instructions are further executable to cause the one or more processing modules to:
send the partial result to a requesting entity.
